(19) United States
(12) Patent Application Publication
(10) Pub. No.: US 2013/0135348 A1
(43) Pub. Date: May 30, 2013

(54) COMMUNICATION DEVICE, COMMUNICATION SYSTEM, COMMUNICATION METHOD, AND COMMUNICATION PROGRAM

(71) Applicant: Jun Anzai, Kanagawa (JP)

(72) Inventor: Jun Anzai, Kanagawa (JP)

(73) Assignee: PANASONIC CORPORATION, Osaka (JP)

(21) Appl. No.: 13/814,705

(22) PCT Filed: Feb. 7, 2012
(86) PCT No.: PCT/JP2012/000801

§ 371 Date: Feb. 6, 2013

(30) Foreign Application Priority Data
Feb. 8, 2011 (JP) 2011-025334

(51) Int. Cl. G06T 19/00

(52) U.S. Cl. CPC G06T 19/006
USPC 345/633

(57) ABSTRACT

A communication device includes a content generation unit that generates annotation generation information for generating annotation corresponding to a physical object, a display requirement setting unit that generates display requirement information indicative of requirements for displaying the annotation, a display object setting unit that generates display object information for identifying the physical object to be displayed where the annotation is displayed, and a communication unit that transmits the annotation generation information, the display requirement information, and the display object information.

### TECHNICAL FIELD

The present invention relates to a communication device, a communication system, a communication method, and a communication program. In particular, the present invention relates to a technique used in an augmented reality (AR) system that provides a user with information (annotation) on an object (physical object) of a reality environment.

### BACKGROUND ART

In recent years, as a technique for adding information to the reality environment by the aid of a computer, and as a term indicative of the environment per se to which the information is added, “augmented reality (also called “augmented reality”)” has been increasingly known. In the augmented reality technique (AR technique), electronic information (annotation) including an explanation about a specific object in the reality environment and related information is provided in association with a real object (physical object) to be explained.

As a technique related to the augmented reality, the following techniques have been known. For example, there has been known a device that calculates the degree of similarity of visual characteristic information extracted from a partial video of a footage and visual characteristic information on the physical object stored in a storage device, and determines whether the physical object exists in the footage or not, according to the calculated degree of similarity. There is known a device that does not display annotation if no physical object exists in the footage (for example, refer to Patent Literature 1).

Also, there has been known a device that measures a distance between the physical object reflected in a real-world video and a viewpoint of the real-world video, and changes the display of annotation according to the acquired distance (for example, refer to Patent Literature 2).

Also, up to now, digital content has been actively sold and delivered, through a communication network such as an internet. As an example of the delivery technique of the digital content, there has been known a system that identifies a potential consumer by the aid of attribute information, position information, and time information, and delivers a content item before the consumer requests the content item (refer to Patent Literature 3). This system enables the consumer to instantly use the content item.

### CITATION LIST

### Patent Literature

Patent Literature 1: Japanese Patent No. 4488233
Patent Literature 2: WO 2010/073616
Patent Literature 3: JP-T-2009-527807

### SUMMARY OF INVENTION

### Technical Problem

As the augmented reality system becomes further widespread in the future, it is expected that a service adopting the augmented reality system is conducted even in an e-mail system using a communication device such as cellular phones. For example, it is expected that some content is provided for the physical object included in an image taken by a camera of the cellular phone through the e-mail.

According to Patent Literature 3, the content that is in tune with consumer tastes can be delivered before the consumer requests the content. If this technique is applied to the augmented reality system disclosed in Patent Literatures 1 and 2, it is conceivable that one side (transmitter side) that provides the annotation as the content can provide the annotation of a specific physical object, and another side (receiver side) to which the annotation is provided can display and confirm the annotation.

However, unless the receiver side displays the annotation taking a variety of situations into consideration, there is a possibility that the annotation is visually impeditive, or there is a possibility that the annotation brings a feeling of strangeness departing from the real world.

The present invention has been made in view of the above circumstances, and an object of the present invention is to provide a communication device, a communication system, a communication method, and a communication program which can provide and display the annotation taking a variety of situations into account.

### Solution to Problem

A communication device according to the present invention includes: an annotation generation unit that is adapted to generate annotation generation information for generating annotation corresponding to a physical object; an information generation unit that is adapted to generate display requirement information indicative of requirements for displaying the annotation, and display object information for identifying the physical object to be displayed where the annotation is displayed; and a transmission unit that is adapted to transmit the annotation generation information generated by the annotation generation unit, the display requirement information generated by the information generation unit, and the display object information generated by the information generation unit.

With the above configuration, the annotation taking the variety of situations into account can be provided by transmitting the information on the display requirements and the display object.

Also, the communication device according to the present invention is configured so that the information generation unit generates guide information presentation requirement information indicative of requirements for presenting guide information for guiding a person who confirms the annotation, and the transmission unit transmits the guide information presentation requirement information generated by the information generation unit.

With the above configuration, a confirming person of the annotation can be guided in surely confirming the annotation at a desired timing.

Also, the communication device according to the present invention is configured so that the information generation unit generates guide information presentation manner information indicative of a manner of presenting the guide information, and the transmission unit transmits the guide information presentation manner information generated by the information generation unit.

With the above configuration, the confirming person of the annotation can be guided in surely confirming the annotation in a desired method.

Also, the communication device according to the present invention is configured by including a reference image storage unit that stores a reference image corresponding to an image of the physical object: therein, wherein the annotation generation unit generates the annotation generation information by the aid of the reference image stored in the reference image storage unit.

With the above configuration, the annotation generation information can be visually easily generated by the aid of a reference image.

Also, a communication device according to the present invention includes: a reception unit that is adapted to receive annotation generation information for generating annotation corresponding to a physical object, display requirement information indicative of requirements for displaying the annotation, and display object information for identifying the physical object to be displayed where the annotation is displayed; a state detection unit that is adapted to detect a state; an image acquisition unit that is adapted to acquire an image; an object recognition unit that is adapted to recognize physical object identification information for identifying a physical object included in the image acquired by the image acquisition unit; a display requirement determination unit that is adapted to determine whether or not information on the state detected by the state detection unit substantially matches the display requirement information received by the reception unit; a display object determination unit that: is adapted to determine whether or not the physical object identification information recognized by the object recognition unit substantially matches the display object information received by the reception unit; and an annotation reconstruction unit that is adapted to reconstruct the annotation based on the annotation generation information received by the reception unit when the display requirement determination unit makes determination of substantial match and the display object determination unit makes determination of substantial match.

With the above configuration, the annotation taking the variety of situations into account can be displayed by acquiring the information on the display requirements and the display object.

Also, the communication device according to the present invention is configured by including a guide information presentation requirement determination unit; and a guide information presentation unit, wherein the reception unit receives guide information presentation requirement information indicative of requirements for presenting guide information for guiding a person who confirms the annotation, the guide information presentation requirement determination unit determines whether or not the information on the state detected by the state detection unit substantially matches the guide information presentation requirement information received by the reception unit, and the guide information presentation unit presents the guide information when the guide information presentation requirement determination unit makes determination of substantial match.

With the above configuration, the confirming person of the annotation can be guided in surely confirming the annotation at the desired timing.

Also, the communication device according to the present invention is configured so that the reception unit receives guide information presentation manner information indicative of a manner of presenting the guide information, and the guide information presentation unit presents the guide information in accordance with the guide information presentation manner information received by the reception unit.

With the above configuration, the confirming person of the annotation can be guided in surely confirming the annotation in the desired manner.

Also, a communication system according to the present invention is a communication system which performs communication between a first communication device and a second communication device, wherein the first communication device includes: an annotation generation unit that is adapted to generate annotation generation information for generating annotation corresponding to a physical object; an information generation unit that is adapted to generate display requirement information indicative of requirements for displaying the annotation, and display object information for identifying the physical object to be displayed where the annotation is displayed; and a transmission unit that is adapted to transmit the annotation generation information generated by the annotation generation unit, the display requirement information generated by the information generation unit, and the display object information generated by the information generation unit, and the second communication device includes: a reception unit that is adapted to receive the annotation generation information, the display requirement information, and the display object information; a state detection unit that is adapted to detect a state; an image acquisition unit that is adapted to acquire an image; an object recognition unit that is adapted to recognize physical object identification information for identifying a physical object included in the image acquired by the image acquisition unit; a display requirement determination unit that is adapted to determine whether or not information on the state detected by the state detection unit substantially matches the display requirement information received by the reception unit; a display object determination unit that is adapted to determine whether or not the physical object identification information recognized by the object recognition unit substantially matches the display object information received by the reception unit; and an annotation reconstruction unit that is adapted to reconstruct the annotation based on the annotation generation information received by the reception unit when the display requirement determination unit makes determination of substantial match and the display object determination unit, makes determination of substantial match.

With the above configuration, the annotation taking the variety of situations into account can be provided and displayed by the aid of the information on the display requirements and the display object.

Also, a first communication method according to the present invention includes the steps of generating annotation generation information for generating annotation corresponding to a physical object; generating display requirement information indicative of requirements for displaying the annotation, and display object information for identifying the physical object to be displayed where the annotation is displayed; and transmitting the annotation generation information, the display requirement information, and the display object information.

With the above method, the annotation taking the variety of situations into account can be provided by transmitting the information on the display requirements and the display object.

Also, a second communication method, according to the present invention includes the steps of: receiving annotation generation information for generating annotation corresponding to a physical object, display requirement information indicative of requirements for displaying the annotation, and display object information for identifying the physical object to be displayed where the annotation is displayed; detecting a state; acquiring an image; recognizing physical object identification information for identifying a physical object included in the acquired image; determining whether or not information on the detected state substantially matches the received display requirement information; determining whether or not the recognized physical object identification information substantially matches the received display Object information: and reconstructing the annotation based on the received annotation generation information when it is determined that the information of the state substantially matches display requirement information and the physical object identification information substantially matches the display object information.

With the above method, the annotation taking the variety of situations into account can be displayed by acquiring the information on the display requirements and the display object.

Also, a communication program according to the present invention is a program for causing a computer to execute each of the steps of the first communication method.

With the above program, the annotation taking the variety of situations into account can be provided by transmitting the information on the display requirements and the display object.

Also, a communication program according to the present invention is a program for causing a computer to execute each of the steps of the second communication method.

With the above program, the annotation taking the variety of situations into account can be displayed by acquiring the information on the display requirements and the display object.

### Advantageous Effects of invention

According to the present invention, the content taking the variety of situations into account can be provided or displayed.

### BRIEF DESCRIPTION OF DRAWINGS

FIG. 1 is a conceptual diagram illustrating an outline of an augmented reality system according to this embodiment in an embodiment of the present invention.

FIG. 2 is a block diagram illustrating a configurative example of a transmission device in the augmented reality system according to the embodiment of the present invention.

FIG. 3 is a block diagram illustrating a configurative example of a reception device in the augmented reality system according to the embodiment of the present invention.

FIG. 4 is a diagram illustrating an operation example of the transmission device according to the embodiment of the present invention.

FIG. 5 is a diagram illustrating the operation example of the transmission device according to the embodiment of the present invention (continued from FIG. 4).

FIG. 6 is a flowchart, illustrating an operation example of the reception device according to the embodiment of the present invention.

### DESCRIPTION OF EMBODIMENTS

Hereinafter, an embodiment of the present invention will be described in detail with reference to the drawings.

As physical objects in this embodiment, terrestrial objects, mobile objects, and locations are assumed. The terrestrial objects represent constructions fixed at specific positions, such as buildings or memorials. The mobile objects represent movable objects such as persons or vehicles. The locations are uniquely specified according to the latitude and longitude, and represent districts unique to specific names such as given spots, parks or streets. Also, as the annotations (content), text information such as character information, and image information such as 2D/3D graphics are assumed. The image includes not only a still image but also a moving image.

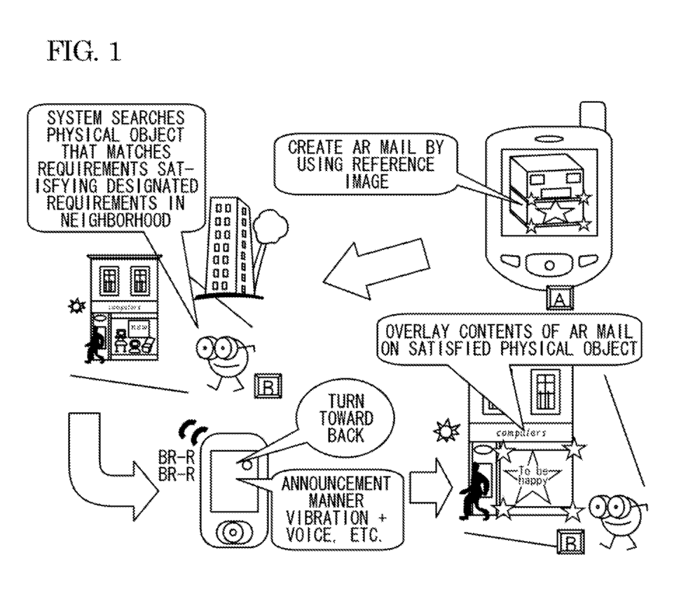

FIG. 1 is a conceptual diagram illustrating an outline of an augmented reality system according to this embodiment. In the augmented reality system according to this embodiment, a communication is conducted between one or a plurality of transmission devices and one or a plurality of reception devices through a mail (AR mail) adopting the AR technique. In FIG. 1, a transmission device A owned by a user A generates information on an annotation corresponding to a given physical object. It is assumed that a reception device B owned by a user B displays the received annotation at a given position within an image taken by a camera function of the reception device B.

First, the transmission device A generates information on the AR mail, and transmits the generated information. In generating the AR mail, the transmission device A generates information on a destination of the AR mail, the contents of the AR mail, a display object, display requirements, the contents of decoration, an announcement method, and the like.

In this example, the information on the destination represents an identification information (e-mail address) for identifying the reception device B owned by the user B. The information on the contents of the AR mail represents information for generating the annotation by the reception device B, and information on the contents corresponding to a message included in a general e-mail. The information on the display object represents physical object identification information for identifying all or a part of the physical object corresponding to the annotation included in the AR mail. The information on the display requirements represents timing information indicative of requirements for displaying the annotation. The information on the contents of decoration represents decoration information for decorating the annotation displayed by the reception device B. The information on the announcement method represents information indicative of a manner of presenting guide information for guiding a recipient who confirms the annotation by the receiver device B.

Upon receiving the respective information from the transmission device A, the reception device B searches a physical object (overall or a part) corresponding to the contents of the AR mail generated by the transmission device A. Upon specifying the physical object, the reception device 13 guides the user B so that the physical object is included in an image taken by the reception device B. The user B is guided by, for example, displaying a message such as “turn toward the back” on a display screen of the reception device B, outputting a voice as a voice message, or conducting presentation by a vibrator. The reception device B, for example, overlays and displays (superimposes and displays) the annotation included in the AR mail for the physical object.

Subsequently, a configuration of the augmented reality system according to the present invention will be described.

In the augmented reality system according to this embodiment, a plurality of communication devices are connected to each other through a communication network such as an internet network or a cellular phone network. The communication devices include the transmission device that transmits the AR mail, and the reception device that receives the AR mail. As the communication device, for example, mobile devices such as cellular phones, personal digital assistants, or notebook computers, and photographing devices such as digital cameras, digital video cameras, or in-vehicle cameras are conceivable.

First, a configuration of the transmission device will be described.

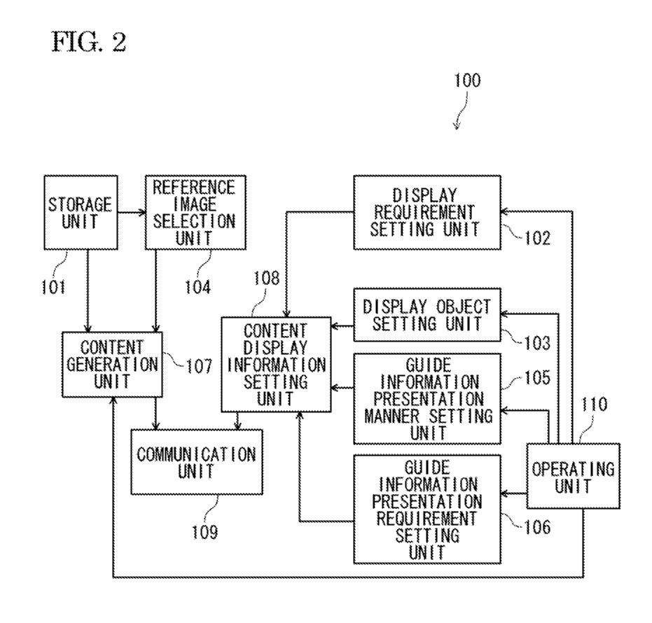

FIG. 2 is a block diagram illustrating a configurative example of a transmission device 100 according to the embodiment of the present invention.

The transmission device 100 includes a storage unit 101, a display requirement setting unit 102, a display object setting unit 103, a reference image selection unit 104, a guide information presentation manner setting unit 105, a guide information presentation requirement setting unit 106, a content generation unit 107, a content display information setting unit 108, a comb communication unit 109, and an operating unit 110.

The storage unit 101 stores a variety of information therein. For example, the storage unit 101 stores a reference image (template image) for designating the display position of the content as the annotation therein. The reference image is, for example, an image that represents a simulated physical object in the real world, which is an image corresponding to the real physical object. The reference image is an image related to a building, a location, and a mobile object as the physical object. Also, the storage unit 101 may store the image taken by the camera not shown, which is provided, in the transmission device 100, as the reference image, or may acquire the reference image by downloading from a given server through the communication unit 109, and store the acquired reference image.

Also, the storage unit 101 stores information on the decoration items, for example, as the decoration information for decorating the content. As the decoration items, the storage unit 101 stores images such as “⋆”, “#”, or “$”, illumination, images related to Christmas or birthday, and sound information as sound effects or BGM therein.

The display requirement setting unit 102 sets requirements for displaying the content by a reception device 200 through the operating unit 110. The information on the set requirements is transmitted to the content display information setting unit 108 as the display requirement information. Also, the display requirement information may not be set.

In this example, the display requirement information includes display time information, recipient attitude information, and moving speed information. The display time information is time information representative of a date at which the content should be displayed, which is information such as xx month, xx day, and xx time. The recipient attitude information is information representative of an attitude of the recipient to be displayed in content, which is information such as looking, looking down, looking ahead, sifting, or sleeping. The moving speed information is information indicative of a moving speed of the reception device 200 to be displayed in content, which is information such as xx km/h, stopping, or getting on a specific vehicle (electric train, car).

Also, aside from the above information, as the display requirement information, there are conceivable information (information on latitude, longitude, and altitude) to be displayed in content, information on a bearing, information on an aspect (information indicative of an aspect of reception device 200), and information on the locations (information on station, downtown, house, or quiet place).

The display object setting unit 103 sets display object information for identifying a display object to be displayed in association with the content through the operating unit 110. The display object information is physical object identification information for identifying the physical object to be displayed in content. The display object information is transmitted to the content display information setting unit 108.

The display object information includes, for example, type information indicative of a type of the physical object, size information indicative of a size of the physical object, color information indicative of a color of the physical object, and complexity information indicative of the complexity of the physical object.

As the type information, a building, a square, and sky are conceivable. As the size information, information regarding an area of the physical object, etc. is conceivable. As the color information, white and a transparent color such as glass are conceivable. As the complexity information, for example, information such that a window of a building as the physical object is flat and simple, or a wall of the building is uneven and complicated is conceivable.

The reference image selection unit 104 refers to template images stored in the storage unit 101, and selects a desired template image from a plurality of template images through the operating unit 110.

The guide information presentation manner setting unit 105 generates the guide information presentation manner information for presenting guide information for guiding a recipient (confirming person) who confirms the content through the operating unit 110 so as to confirm the content corresponding to the physical object through a display unit 213 of the reception device 200 or a speaker not shown. The guide information presentation manner information is transmitted to the content display information setting unit 108.

The guide information presentation manner information is information for presenting the information such as “turn toward the hack” or “look up” by voice, characters, or images, information for displaying icons or arrows in the display unit 213 of the reception device 200, or information for conducting presentation by a vibrator.

The guide information presentation requirement setting unit 106 sets requirements for presenting the guide information through the operating unit 110. The information on the set requirements is transmitted to the content display information setting unit 108 as the guide information presentation requirement information.

In this example, the guide information presentation requirement information includes reception device state information indicative of a state of the reception device 200, recipient state information indicative of a state of the recipient owned by the reception device 200, and instant presentation information indicating that the guide information is presented immediately when the display requirement of the content is met.

As the reception device state information, there are information indicative of whether the reception device 200 is activating the AR application, or not, information indicative of whether a power supply of the display unit 213 (LCD (liquid crystal display), etc.) of the reception device 200 is off, or not, and information indicative of whether an e-mail communication is being conducted by a communication unit 201 of the reception device 200, or not.

As the recipient state information, there are information indicative of whether the recipient is walking, or not, information indicative of whether the recipient is stopping, or not, and information indicative of whether the recipient faces the opposite direction of the physical object corresponding to the content to be displayed.

The content generation unit 107 generates content generation information for generating the content through the operating unit 110. In this situation, the content generation unit 107 can generate annotation generation information by the aid of the template image.

For example, the content generation unit 107 designates a display position at which the content is to be displayed by the aid of the template image selected by the reference image selection unit 104. The position information related to the display position is designated, for example, as a coordinate position in the template image. The display position at which the content is displayed is designated in the image taken by a camera unit 205 of the reception device 200, in correspondence with the designation of the display position.

Also, the content generation unit 107 generates the character information (text information) and the image information, which are included in the content, through the operating unit 110. For example, in the example illustrated in FIG. 1, the content generation unit 107 generates a character string of “To Be Happy” and an image “⋆” (star) behind the character string. Also, in the example illustrated in FIG. 1, the content generation unit 107 generates an image (edging with a red frame, double outer frame, etc.) for emphasizing an area where the content is displayed. The content generation unit 107 also generates information on a position at which the character string is displayed, a character color, a direction of characters (italic type, etc.), a size of characters, and a font of characters in the content together with the characters per se.

Also, the content generation unit 107 refers to the decoration items stored in the storage unit 101, and selects a desired decoration item from the plurality of decoration items through the operating unit 110.

Also, the content generation unit 107 designates a display position at which the selected decoration item is to be displayed on the template image selected by the reference image selection unit 104. The display position at which the decoration items are displayed is designated in the image taken by the camera unit 205 of the reception device 200, in correspondence with the designation of the display position.

The content generation unit 107 sets the content generation information (information generated, designated, and selected by the content generation unit 107) for generating the above content, as at least a part of a message, a header, and an attachment of the AR mail. Also, the content generation unit 107 may set the generated content per se for the AR mail.

The content display information, setting unit 108 sets the content display information for displaying the content by the reception device 200 as at least a part, of the message, the header, and the attachment of the AR mail. The content display information include the display requirement information from the display requirement setting unit 102, the display object information from the display object setting unit 103, the guide information presentation manner information from the guide information presentation manner setting unit 105, and the guide information presentation requirement information from the guide information presentation requirement setting unit 106.

The communication unit 109 transmits the AR mail including the content generation information generated by the content generation unit 107 and the content display information set by the content display information setting unit 108, to the reception device 200 through a given communication network.

The operating unit 110 accepts a manipulated input from the user, and is formed of for example, a numerical keypad, an arrow key, or a touch panel.

Subsequently, the configuration of the reception device will be described.

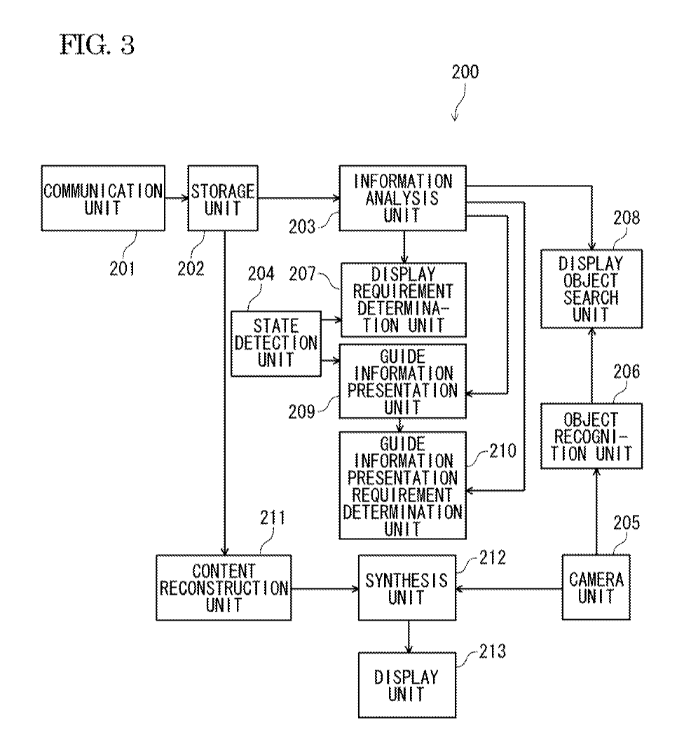

FIG. 3 is a block diagram illustrating a configurative example of the reception device 200 according to the embodiment of the present invention.

The reception device 200 includes the communication unit 201, a storage unit 202, an information analysis unit 203, a state detection unit 204, the camera unit 205, an object recognition unit 206, a display requirement determination unit 207, a display object search unit 208, a guide information presentation requirement determination unit 209, a guide information presentation unit 210, a content reconstruction unit 211, a synthesis unit 212, and the display unit 213.

The communication unit 201 receives the AR mail from the transmission device 100 through the given communication network. The AR mail includes the content generation information and the content: display information.

The storage unit 202 stores a variety of information therein. For example, the storage unit 202 stores the content generation information received by the communication unit 201 and the content display information in association with each other.

The information analysis unit 203 extracts and analyzes the display requirement information, the display object information, the guide information presentation manner information, and the guide information presentation requirement information, which are included in the content display information stored in the storage unit 202.

The state detection unit 204 detects a variety of states. For example, the state detection unit 204 has a GPS function to detect the position information (information on latitude, longitude, altitude, or the like) of the reception device 200. Also, the state detection unit 204 has a geomagnetic sensor to detect the information (information on bearing of north, south, east and west) on the aspect of the reception device 200. Also, the state detection unit 204 has an acceleration sensor and a speed sensor to detect the information on the moving speed of the reception device 200. Also, the state detection unit 204 has a timer to detect time information. Also, the state detection unit 204 acquires information on the other component parts within the reception device 200 to detect that a power supply of the display unit 213 or the like is off.

The camera unit 205 is a photographing device that takes a still image or a moving image in 2D or 3D, and is formed of, for example, a CCD image sensor or a CMOS image sensor.

The object recognition unit 206 conducts a feature extracting process for extracting a feature of the image taken by the camera unit 205. In the feature extracting process, a known feature extracting method such as feature extraction or edge extraction is used. The object recognition unit 206 conducts a recognizing process for recognizing the physical object from the extracted feature. In the recognizing process, a known image recognizing method such as pattern matching is used. Through the recognizing process, the object recognition unit 206 recognizes the physical object identification information for identifying the physical object, and recognizes the physical object as the display object.

As the physical object identification information recognized by the recognizing process, there are conceivable type information, size information, color information, and complexity information. As the type information, there are conceivable doors, buildings, ground, and sky. As the size information, information that an area of the physical object is large, middle, or small is conceivable. As the color information, white or transparent color such as glass is conceivable. As the complexity information, for example, there is information that the physical object is wholly configured by a plane, or that the physical object is rough and bumpy. That is, this information corresponds to the display object information set by the transmission device 100.

The display requirement determination unit 207 determines whether to satisfy the requirements for displaying the content stored in the storage unit 202, or not. For example, the display requirement determination unit 207 determines that the requirements for displaying the content are satisfied if the display requirement information analyzed by the information analysis unit 203 substantially matches the information (information such as display time information, recipient attitude information, or moving speed information) corresponding to the display requirement information among the information on the state detected by the state detection unit 204.

The display object search unit 208 searches the physical object to be displayed in correspondence with the content from the image taken by the camera unit 205. For example, if the display object information analyzed by the information analysis unit 203 substantially matches the physical object identification information recognized by the object recognition unit 206, the display object search unit 208 specifies the physical object identified by the physical object identification information as the physical object to be displayed.

The guide information presentation requirement determination unit 209 determines whether to satisfy the requirements under which the guide information for guiding the recipient who confirms the content are presented, or not. For example, the guide information presentation requirement determination unit 209 determines that the requirements under which the guide information is presented are satisfied if the guide information presentation requirement information analyzed, by the information analysis unit 203 substantially matches the information (information such as reception device state information or recipient state information) corresponding to the guide information presentation requirement information among the information on the state detected by the state detection unit 204.

The guide information presentation unit 210 presents the guide information according to the guide information presentation manner information analyzed by the information analysis unit 203, through the display unit 213, a speaker not shown, or a vibration not shown.

The content reconstruction unit 211 reconstructs the content on the basis of the content generation information stored in the storage unit 202. In this situation, the content reconstruction unit 211 generates the character string and the image included in the content to further reconstruct the decoration items on the basis of the content generation information.

For example, the content reconstruction unit 211 recognizes the display position of the content according to the information (on the display position) designated by the transmission device 100. Also, the content reconstruction unit 211 recognizes the contents of the content according to the character information or the image information. Also, the content reconstruction unit 211 recognizes the position at which the character string is displayed, the character color, the direction of characters (italic type, etc.), the size of characters, and the font of characters according to the information generated by the transmission device 100. Also, the content reconstruction unit 211 recognizes the information on the decoration items according to the information (on the decoration items) selected by the transmission device 100. The content reconstruction unit 211 may store the decoration items in the storage unit 202 in advance, or may acquire the decoration items per se from the transmission device 100 through the communication unit 201.

The synthesis unit 212 synthesizes the image taken by the camera unit 205 with the content reconstructed by the content reconstruction unit 211. As a result, the content is associated with the physical object included in the image in a form intended by the transmission device 100.

The display unit 213 are a liquid crystal display (LCD) or a head mounted display (HMD), and displays the physical object and the content which are associated and synthesized with each other by the synthesis unit 212. In the display of the display unit 213, for example, the content is overlaid and displayed (superimposed and displayed) on the physical object. Also, the display unit 213 may project the content on the physical object for display by the aid of a projector.

Subsequently, the operation of the transmission device 100 will be described.

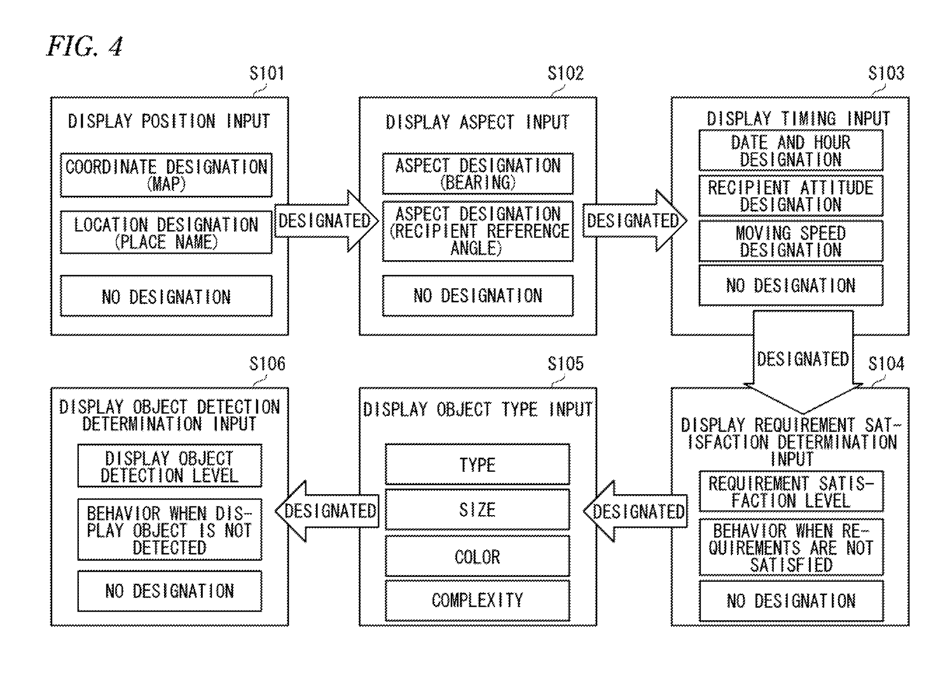

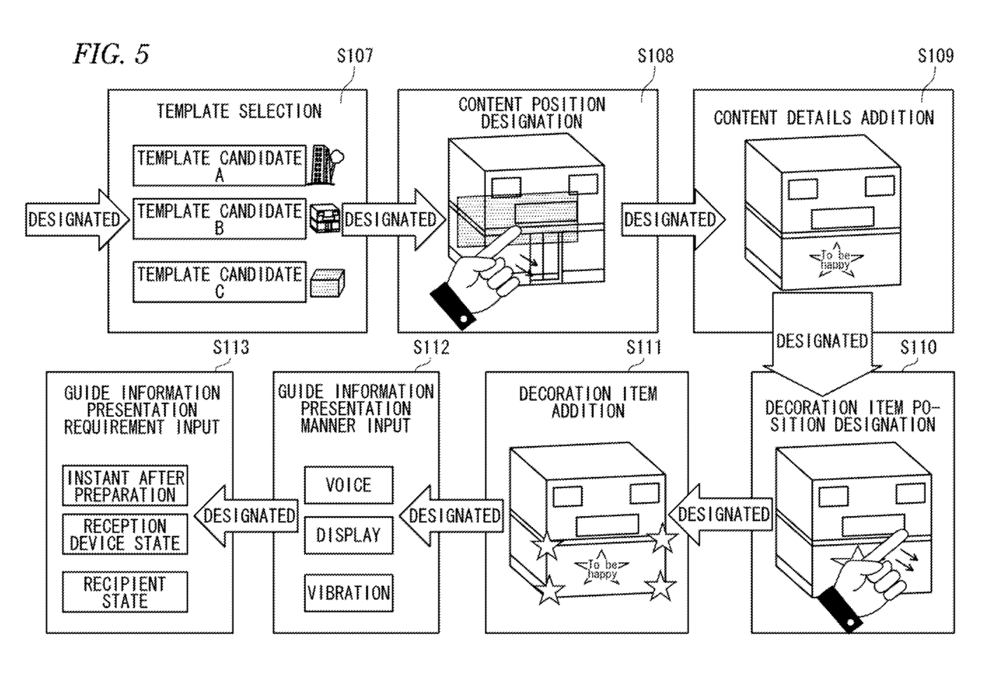

FIGS. 4 and 5 are diagrams illustrating the operation example of the transmission device 100.

First, the display requirement setting unit 102 sets the display requirement information through the manipulated input to the operating unit 110. In this example, the display requirement setting unit 102 sets, as the display requirement information, the information on the display position (Step S101), the information on the display aspect (Step S102), the information on the display timing (Step S103), and the information on the display requirement satisfaction (Step S104) in sequence.

The information on the display position is set by designating the coordinates on a given map through the operating unit 110, or inputting a place name to designate the location through the operating unit 110. The reception device 200 can recognize the display position according to information acquired by a GPS or the like. The information on the display position may not be set.

The information on the display aspect is set by designating the aspect (bearing) of the reception device 200 to be displayed in the content through the operating unit 110, or designating the aspect (recipient reference angle) of the reception device 200 on the basis of the recipient through the operating unit 110. The reception device 200 can recognize the display aspect according to the information acquired by the geomagnetic sensor. The information on the display aspect may not be set.

The information on the display timing is set by designating a time such as date and hour through the operating unit 110, designating the attitude (inclination of reception device 200) of the recipient through the operating unit 110, or designating the moving speed of the reception device 200 through the operating unit 110. The reception device 200 can recognize the time according to the information acquired by a timer or the like. Also, the reception device 200 can recognize the inclination of the reception device 200 according to the information acquired by a gyro sensor or the like. Also, the reception device 200 can recognize the moving speed of the reception device 200 according to the information acquired by a speed sensor. The information on the display timing may not be set.

The information on the display requirement satisfaction is set by designating a satisfaction level of the display requirements through the operating unit 110, or designating a behavior when the display requirements are not satisfied through the operating unit 110. In this example, the information on the satisfaction level of the display requirements is information on whether to satisfy an essential display requirement among the plurality of display requirements, how in any inessential display requirements to be satisfied, or how much error to be permitted as compared with the display requirements. The information on the permissible error may be set by the display requirement setting unit 102 in advance, and transmitted to the reception device 200 by the communication unit 109. Also, the information on the behavior when the display requirements are not satisfied is information such that the satisfaction level of the display requirements is reduced, or that the content: is displayed in time-out even if the display requirements are not: satisfied. The reception device 200 can recognize the satisfaction level of the display requirements on the basis of the information acquired by the respective state detection sensors. The information on the display requirement satisfaction may not: be set.

Subsequently, the display object setting unit 103 sets the display object information through the manipulated input to the operating unit 110. In this example, the display object setting unit 103 sets, as the display object information, the information on the display object type (Step S105) and the information on the display object detection (Step S106) in sequence.

The information on the display object type is set by designating the type information through the operating unit 110, designating the size information through the operating unit 110, designating the color information through the operating unit 110, or designating the complexity information through the operating unit 110. The reception device 200 can recognize the above information by the object recognition unit 206.

The information on the display object: detection is set by designating the detection level of the display object through the operating unit 110, or designating the behavior when the display object is not detected through the operating unit 110. In this example, the information on the detection level of the display object is information on whether to satisfy an essential display requirement among the information on the display object type, how many inessential display requirements to be satisfied, or how much error to be permitted as compared with the display requirements. The information on the permissible error may be set by the display object setting unit 103 in advance, and transmitted to the reception device 200 by the communication unit 109. Also, the information on the behavior when the display object is not detected is information such that the detection level of the display object is reduced, that the content is displayed in time-out even if unsatisfied, that the content is displayed even if the display object is not detected, that the content is not displayed if the display object, is not detected, or that the content is displayed even if the display object is similar in the information on the display object type. The reception device 200 can recognize the detection level of the display object on the basis of the information acquired by the respective state detection sensors. The information on the display object detection may not be set.

Subsequently, the reference image selection unit 104 extracts the template image that substantially matches the information of the display object type set in Step S105 from the template images stored in the storage unit 101. The reference image selection unit 104 selects a desired template image from the extracted template image through the manipulated input to the operating unit 110 (Step S107). In an example illustrated in FIG. 5, template candidates A to C are stored in the storage unit 101 as the template images. In this example, the reference image selection unit 104 selects the template candidate B so as to provide the content corresponding to the physical object similar to the template candidate B.

Also, the reference image selection unit 104 may select, on the basis of the information on the display position set in Step S101, what is close to the physical object assumed to be located at the display position, through the operating unit 110. Also, the reference image selection unit 104 may acquire, in cooperation with a server having the information on the display position set in Step S101, an image of the real physical object from the server by the communication unit 109.

Subsequently, the content generation unit 107 designates the display position (display area) in the template image at which the content is displayed, through the manipulated input to the operating unit 110 (Step S108). In the example illustrated in FIG. 5, the content generation unit 107 designates a front portion of a ground floor of a building as the display position of the content. The content generation unit 107 may designate the display area in an area other than a rectangle.

Subsequently, the content generation unit 107 sets the detail of the content through the manipulated input to the operating unit 110 (Step S109). In the example illustrated in FIG. 5, the content generation unit 107 sets blue as a background color, a red thick line in an outer peripheral, portion, ⋆ mark (⋆ mark) in the center portion, and “To Be Happy” as characters, in the display area of the content designated in Step S108. Further, the content generation unit 107 also sets the font, size, and color of the characters. The above information is set in the content generation information.

Subsequently, the content generation unit 107 designates the display position (display area) at which the decoration item is displayed, through the manipulated input to the operating unit 110 (Step S110). In the example illustrated in FIG. 5, the content generation unit 107 designates four corners of the rectangle as the display area of the content, as the display area of the decoration item. The content generation unit 107 may designate the display area in the area other than the rectangle.

Subsequently, the content generation unit 107 selects a desired decoration item from the decoration items stored in the storage unit 101, through the manipulated input to the operating unit 110 (Step S110. In the example illustrated in FIG. 5, the content generation unit 107 selects a star image “⋆” as the decoration item.

Thus, the content generation unit 107 generates the details of the content including the decoration item through the processing of Steps S108 to S111 in FIG. 5.

Subsequently, the guide information presentation manner setting unit 105 sets the guide information presentation manner information, through the manipulated input to the operating unit 110 (Step S112). The guide information presentation manner information is set by designating the presentation of the guide information by a voice through the operating unit 110, designating the presentation of the guide information by display through the operating unit 110, or designating the presentation of the guide information by vibration through the operating unit 110

Subsequently, the guide information presentation requirement setting unit 106 sets the guide information presentation requirement information, through the manipulated input to the operating unit 110 (Step S113). The guide information presentation requirement information is set by designating the reception device state information through the operating unit 110, designating the recipient state information through the operating unit 110, or designating the instant presentation information through the operating unit 110. The reception device 200 can recognize the state of the reception device 200 and the state of the recipient according to the information acquired from the respective state detection sensors.

Subsequently, the communication unit 109 transmits, to the reception device 200, the content generation information generated by the content generation unit 107, and the content display information set by the content display information setting unit 108. In this example, the content generation information may be the content image per se generated in Steps S108 to S111, or information (metadata) for reconstructing the content generated by the transmission device. The metadata includes the respective information designated in Steps S108 to S111.

According to the above operation of the transmission device 100, there can be provided the content as the annotation taking a variety of situations into account. Also, since the content generation information can be generated by the aid of the reference image similar to the real physical object, the annotation of the physical object which is located at a place where a transmitter owning the transmission device 100 has not visited can be generated.

In the respective Steps S101 to S113 in FIGS. 4 and 5, the transmission device 100 may display the images illustrated in FIGS. 4 and 5 on the display screen of the transmission device 100, and execute an input by the touch panel through the operating unit 110 to conduct intuitive operation. Also, the transmission device 100 may execute the designation in the respective Steps S101 to S113 in a wizard form or a navigation form.

Subsequently, the operation of the reception device 200 will be described.

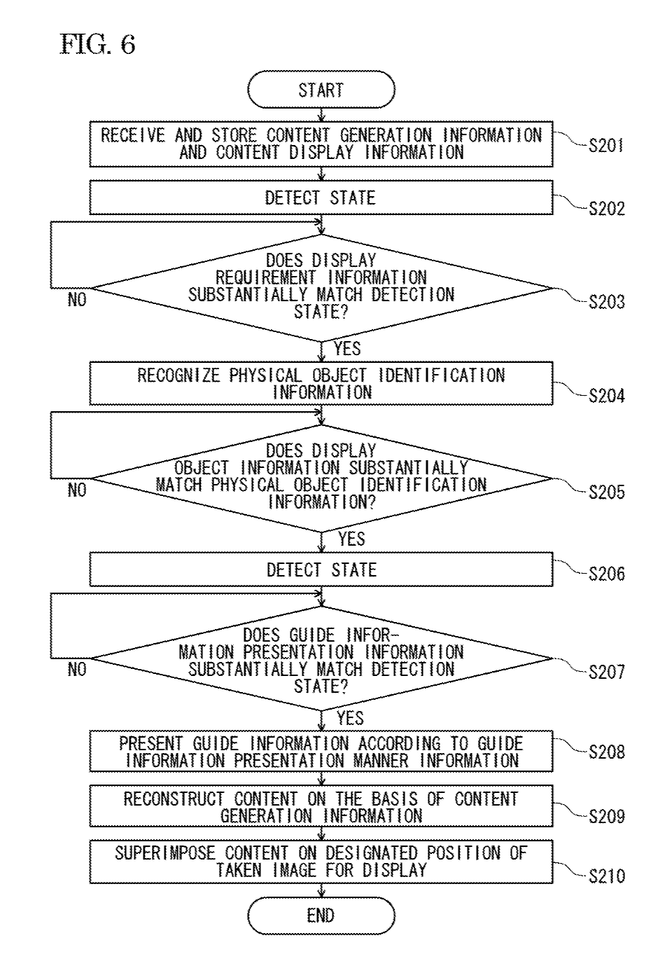

FIG. 6 is a flowchart illustrating an operation example of the reception device 200. In FIG. 6, it is assumed that an image is taken by the camera unit 205 during window-shopping, and the content is superimposed and displayed on a window of a shop included in the taken image.

First, the communication unit 201 receives information including the content generation information and the content display information from the transmission device 100, and the storage unit 202 stores the above information therein (Step S201). The information analysis unit 203 analyzes the content display information among the information stored in the storage unit 202.

Subsequently, the state detection unit 204 detects a variety of states (Step S202). For example, the state detection unit 204 detects a time by a clock (timer), detects the position of the reception device 200 by a GPS, detects an aspect of the reception device 200 by a geomagnetic sensor, and detects the moving speed of the reception device 200 by a speed sensor.

Subsequently, the display requirement determination unit 207 determines whether the display requirement information included in the content display information analyzed by the information analysis unit 203 substantially matches the state detected by the state detection unit 204, or not (Step S203). In this example, the display requirement information includes, for example, information such as “after 18:00 of June 7 (Fri)” as the information on the display timing, “35 degrees of latitude and 139 degrees of longitude” as the information on the display position, “east” as the information on the display aspect, or “stopping for one minute or longer” as the information on the moving speed.

Also, when the information on the display requirement satisfaction is set, the display requirement determination unit 207 determines whether the display requirement information substantially matches the information on the detected state, or not, taking the set information into account. For example, it is assumed that the information on the display requirement satisfaction is set with “date and hour” as the information on the essential requirements, “1” as the information on the number of option requirements to be satisfied, and “within 20%” as the information on the permissible error. In this case, if a difference between “after 18:00 of June 7 (Fri)” and the time information detected by the state detection unit 204 falls within 20% (within a given range), and the other requirements, for example, a difference between “35 degrees of latitude and 1.39 degrees of longitude” and the position information detected by the state detection unit 204 falls with 20% (within a given range), the display requirement determination unit 207 determines that the display requirements are satisfied.

If both information does not substantially match each other in Step S203, Step S203 is repeated until the information substantially matches each other.

If both information substantially matches each other in Step S203, the object recognition unit 206 recognizes the physical object identification information (type information, size information, color information, and complexity information) from the image taken by the camera unit 205 for each of the physical objects (Step S204).

Subsequently, the display object search unit 208 determines whether the display object information included in the content display information analyzed by the information analysis unit 203 substantially matches the physical object information recognized by the object recognition unit 206, or not. (Step S205). In this example, the display object information includes, for example, information such as “two-storied building” as the type information, “middle” as the size information, “glass” as the color information, or “all planes” as the complexity information.

Also, when the information on the display object detection is set, the display object search unit 208 determines whether the display object information substantially matches the recognized physical object identification information, or not, taking the set information into account. For example, it is assumed that the information on the display object detection is set with “color” as the information on the essential requirements, “1” as the information on the number of option requirements to be satisfied, and “within 30%” as the information on the permissible error. In this case, if a difference between “glass” and the color information recognized by the object recognition unit 206 falls within 30% (within, a given range), and the other requirements, for example, a difference between “middle” and the size information recognized by the object recognition unit 206 falls with 30% (within a given range), the display object search unit 208 determines that the physical object is to be displayed.

If both information does not substantially, match each other in Step S205, Step S205 is repeated until the information substantially matches each other.

If both information substantially matches each other in Step S205, the state detection unit 204 detects a variety of states (Step S206). For example, the state detection unit 204 detects a time by a clock. (timer), detects the position by a GPS, detects the aspect of the reception device 200 by a geomagnetic sensor, detects the moving speed of the reception device 200 by a speed sensor, detects a running application (during AR, during mail) by an application monitor unit not shown, and detects whether the power supply of the display unit 213 is on or not, by a power monitor unit not shown.

Subsequently, the display object search unit 208 determines whether the guide information presentation requirement information included in the content display information analyzed by the information analysis unit 203 substantially matches the state detected by the state detection unit 204, or not (Step S207). In this example, the guide information presentation requirement information includes, for example, information such as “during execution of AR application” as the reception device state information. “during stop” as the recipient state information, or “No” as the instant presentation information.

If both information does not substantially match each other in Step S207, Step S207 is repeated until the information substantially matches each other.

If both information substantially matches each other in Step S207, the guide information presentation unit 210 presents the guide information according to the guide information presentation manner information included in the content display information analyzed by the information analysis unit 203 (Step S208). In this example, the guide information presentation manner information includes, for example, information such as “short distance from window” as the information for presentation by a voice, “arrow indication toward window” as the information for presentation by display, or “vibration ON” as the information for presentation by vibration.

If the recipient can confirm the content without presenting the guide information, a process for presenting the guide information may be omitted. That is, processing in Steps S206 to S208 may be omitted.

Subsequently, the content reconstruction unit 211 extracts the content generation information from the content generation information stored in the storage unit 202. In this example, the content generation information includes, for example, information such as “center” as the information on the position within the content: at which a text or an image is arranged, “red” as the information on the color of the text or the image, “inclination 20 degrees” as the information on the aspect of the text or the image, “20 point, Gothic” as the information on the font of the text, “(321, 220)” (coordinate information) as the information on the position of the display object in the taken image, “star image on top” as the information on edges of the content (information on display position of decoration item and information on contents of decoration item), or “bluing” as the information on the background of the content.

Subsequently, the content reconstruction unit 211 reconstructs the content on the basis of the extracted content generation information (Step S209). For example, if the above information is included in the content generation information, the content completed in Step S111 of FIG. 5 is reconstructed by the display unit 213.

Subsequently, the synthesis unit 212 superimposes the content reconstructed by the content reconstruction unit 211 on a position of the image taken by the camera unit 205, which is designated by the transmission device 100 (position of display object included in content generation information) for combination, and the display unit 213 displays the synthesized image (Step S210).

According to the above operation of the reception device 200, the content can be presented taking a variety of situations into account. Also, if the permissible error of the display requirements and the display object falls within a given range, the reception device 200 may generate the content according to the site and the shape of the real physical object included in the taken image. That is, the reception device 200 may the reception device 200 may process the information included in the content generation information in some degree to generate the content. As a result, the reception device 200 can display the content according to the real physical object.

According to the above augmented reality system, the annotation (content) can be displayed, for example, in the following situations (1) to (8).

(1) Display the annotation on a window of an opposite building seen from an inside of a certain building.

(2) Display the annotation on an overall back building when a person looks behind, during walking.

(3) Display the annotation in a sky at which a person inadvertently looks up in the evening

(4) Display the annotation on a window during window-shopping

(5) Display the annotation when a person looks down in a square

(6) Display the annotation in an entrance of a house to which a person returns in his/her birthday.

(7) Display the annotation on a ceiling when a person lies on a bed

(8) Display the annotation on an overall side surface (lateral, side) of a bus during commuting

Also a graphical e-mail can be displayed according to the physical object in the real world. Accordingly, the possibility that the display of the annotation becomes visually impeditive is extremely low, and the annotation can be integrated into the real world and displayed. Also, since the annotation can be displayed according to the status of the recipient or the reception device 200, for example, the annotation can be displayed at the moment when the person turns around, or the annotation can be displayed at the moment when the person looks up.

In the augmented reality system according to this embodiment, the transmission device 100 and the reception device 200 share the information by the e-mail communication with each other, but may share the information by a method other than the e-mail communication.

The present invention has been described, in detail and with reference to the specific embodiment. However, it would be apparent to those skilled in the art that various modifications and improvements may be made without departing from the scope and spirit of the invention.

The present application is based on Japanese Patent Application No. 2011-025334 filed on Feb. 8, 2011, the contents of which are incorporated herein by reference.

### INDUSTRIAL APPLICABILITY

The present invention is useful to the communication device, the communication system, the communication program, and the like which can present and display the content taking a variety of situations into account.

### REFERENCE SIGNS LIST

100: transmission device
101: storage unit.
102: display requirement setting unit
103: display object setting unit
104: reference image selection unit
105: guide information presentation manner setting unit
106: guide information presentation requirement setting unit
107: content generation unit
108: content display information setting unit
109: communication unit
110: operating unit
200: reception device
201: communication unit
202: storage unit
203: information analysis unit
204: state detection unit.
205: camera unit.
206: object recognition unit
207: display requirement: determination unit
208: display object search unit
209: guide information presentation requirement determination unit
210: guide information presentation unit
211: content reconstruction unit
212: synthesis unit
213: display unit

1. A communication device, comprising:
an annotation generation unit that is adapted to generate annotation generation information for generating annotation corresponding to a physical object;
an information generation unit that is adapted to generate display requirement information indicative of requirements for displaying the annotation, and display object information for identifying the physical object to be displayed where the annotation is displayed; and
a transmission unit that is adapted to transmit the annotation generation information generated by the annotation generation unit, the display requirement information generated by the information generation unit, and the display object information generated by the information generation unit.

2. The communication device according to claim 1, wherein
the information generation unit generates guide information presentation requirement information indicative of requirements for presenting guide information for guiding a person who confirms the annotation, and
the transmission unit transmits the guide information presentation requirement information generated by the information generation unit.

3. The communication device according to claim 2, wherein
the information generation unit generates guide information presentation manner information indicative of a manner of presenting the guide information, and
the transmission unit transmits the guide information presentation manner information generated by the information generation unit.

4. The communication device according to claim 1, further comprising:
a reference image storage unit that stores a reference image corresponding to an image of the physical object therein, wherein
the annotation generation unit generates the annotation generation information by the aid of the reference image stored in the reference image storage unit.

5. A communication device, comprising:
a reception unit that is adapted to receive annotation generation information for generating annotation corresponding to a physical object, display requirement information indicative of requirements for displaying the annotation, and display object information for identifying the physical object to be displayed where the annotation is displayed;
a state detection unit that is adapted to detect a state;
an image acquisition unit that is adapted to acquire an image;
an object recognition unit that is adapted to recognize physical object identification information for identifying a physical object included in the image acquired by the image acquisition unit;
a display requirement determination unit that is adapted to determine whether or not information on the state detected by the state detection unit substantially matches the display requirement information received by the reception unit;
a display object determination unit that is adapted to determine whether or not the physical object identification information recognized by the object recognition unit substantially matches the display object information received by the reception unit; and
an annotation reconstruction unit that is adapted to reconstruct the annotation based on the annotation generation information received by the reception unit when the display requirement determination unit makes determination of substantial match and the display object determination unit makes determination of substantial match.

6. The communication device according to claim 5, further comprising:
a guide information presentation requirement determination unit; and
a guide information presentation unit, wherein
the reception unit receives guide information presentation requirement information indicative of requirements for presenting guide information for guiding a person who confirms the annotation,
the guide information presentation requirement determination unit determines whether or not the information on the state detected by the state detection unit substantially matches the guide information presentation requirement information received by the reception unit, and
the guide information presentation unit presents the guide information when the guide information presentation requirement determination unit makes determination of substantial match.

7. The communication device according to claim 6, wherein
the reception unit receives guide information presentation manner information indicative of a manner of presenting the guide information, and
the guide information presentation unit presents the guide information in accordance with the guide information presentation manner information received by the reception unit.

8. A communication system which performs communication between a first communication device and a second communication device, wherein
the first communication device comprises:
an annotation generation unit that is adapted to generate annotation generation information for generating annotation corresponding to a physical object;
an information generation unit that is adapted to generate display requirement information indicative of requirements for displaying the annotation, and display object information for identifying the physical object to be displayed where the annotation is displayed; and
a transmission unit that is adapted to transmit the annotation generation information generated by the annotation generation unit, the display requirement information generated by the information generation unit, and the display object information generated by the information generation unit, and
the second communication device comprises:
a reception unit that is adapted to receive the annotation generation information, the display requirement information, and the display object information;
a state detection unit that is adapted to detect a state;
an image acquisition unit that is adapted to acquire an image;
an object recognition unit that is adapted to recognize physical object identification information for identifying a physical object included in the image acquired by the image acquisition unit;
a display requirement determination unit that is adapted to determine whether or not information on the state detected by the state detection unit substantially matches the display requirement information received by the reception unit;
a display object determination unit that is adapted to determine whether or not the physical object identification information recognized by the object recognition unit substantially matches the display object information received by the reception unit; and
an annotation reconstruction unit that is adapted to reconstruct the annotation based on the annotation generation information received by the reception unit when the display requirement determination unit makes determination of substantial match and the display object determination unit makes determination of substantial match.

9. A communication method, comprising:
generating annotation generation information for generating annotation corresponding to a physical object;
generating display requirement information indicative of requirements for displaying the annotation, and display object information for identifying the physical object to be displayed where the annotation is displayed; and
transmitting the annotation generation information, the display requirement information, and the display object information.

10. A communication method, comprising:
receiving annotation generation information for generating annotation corresponding to a physical object, display requirement information indicative of requirements for displaying the annotation, and display object information for identifying the physical object to be displayed where the annotation is displayed;
detecting a state;
acquiring an image;
recognizing physical object identification information for identifying a physical object included in the acquired image;
determining whether or not information on the detected state substantially matches the received display requirement information;
determining whether or not the recognized physical object identification information substantially matches the received display object information; and
reconstructing the annotation based on the received annotation generation information when it is determined that the information of the state substantially matches display requirement information and the physical object identification information substantially matches the display object information.

11. A non-transitory computer-readable storage medium in which is stored a communication program for causing a computer to execute each of the steps of the communication method as defined in claim 9.

12. A non-transitory computer-readable storage medium in which is stored a communication program for causing a computer to execute each of the steps of the communication method as defined in claim 10.
